(19) United States
(12) Patent Application Publication
(10) Pub. No.: US 2011/0296105 A1
(43) Pub. Date: Dec. 1, 2011

(54) SYSTEM AND METHOD FOR REALIZING RAID-1 ON A PORTABLE STORAGE MEDIUM

(76) Inventors: Hsieh-Huan Yen, Taipei City (TW); Hsuan-Ching Chao, Keelung City (TW); Teng-Chuan Hsieh, New Taipei City (TW)

(21) Appl. No.: 13/149,823

(22) Filed: May 31, 2011

Related U.S. Application Data
(60) Provisional application No. 61/350,031, filed on Jun. 1, 2010.

(30) Foreign Application Priority Data
May 9, 2011 (TW) 100116098

(51) Int. Cl. G06F 12/16

(52) U.S. Cl. 711/114; 711/E12.103

(57) ABSTRACT

A system of realizing RAID-1 on a portable storage medium includes a Universal Serial Bus device and the portable storage medium. The portable storage medium is divided into a main partition and at least one backup partition according to a RAID-1 mode. The Universal Serial Bus device is coupled to the portable storage medium for receiving a write command and/or a read command transmitted by a host, and writing data to the portable storage medium and/or reading data from the portable storage medium according to the write command and/or the read command. The Universal Serial Bus device does not transmit capacity information of the at least one backup partition to the host.

### CROSS REFERENCE TO RELATED APPLICATIONS

This application claims the benefit of U.S. Provisional Application No. 61/350,031, filed on Jun. 1, 2010 and entitled “Virtual RAID-1 Implemented in USB Portable Single Mass Storage Media,” the contents of which are incorporated herein by reference.

### BACKGROUND OF THE INVENTION

1. Field of the Invention

The present invention is related to a system of a portable storage medium and method thereof, and particularly to a system and method thereof that realize writing/reading data under redundant array of independent disks (RAID) on a portable storage medium.

2. Description of the Prior Art

Technological advances lead to increased capacity of a portable storage medium, so a user can take large amounts of data anywhere at any time. Although the user can store large amounts of data in the portable storage medium, the whole portable storage medium uses the same sector, so that the user utilizes the same sector to store/read data. If the portable storage medium is abnormal (that is, the same sector is abnormal), the user may not read corresponding data from the portable storage medium again. Therefore, utilizing the same sector to store/read data is not an ideal method for the user.

### SUMMARY OF THE INVENTION

An embodiment provides a system for realizing RAID-1 on a portable storage medium. The system includes a Universal Serial Bus device and a portable storage medium. The portable storage medium is divided into a main partition and at least one backup partition according to a virtual RAID-1 mode. The Universal Serial Bus device is coupled to the portable storage medium, for receiving a write command and/or a read command transmitted by a host, and writing data to the portable storage medium and/or reading data from the portable storage medium according to the write command and/or the read command; wherein the Universal Serial Bus device does not transmit capacity information of the at least one backup partition to the host.

Another embodiment provides a method of realizing writing data under RAID-1 on a portable storage medium. The method includes dividing the portable storage medium into a main partition and at least one backup partition according to a virtual RAID-1 mode; a Universal Serial Bus device receiving a write command transmitted from a host; the Universal Serial Bus device writing data to the main partition and the at least one backup partition according to the write command; the Universal Serial Bus device transmitting a state and capacity information of the main partition to the host, and the Universal Serial Bus device not transmitting capacity information of the at least one backup partition to the host.

Another embodiment provides a method for realizing writing/reading data under RAID-1 on a portable storage medium. The method includes dividing the portable storage medium into a main partition and at least one backup partition according to a virtual RAID-1 mode; a Universal Serial Bus device receiving a read command transmitted from a host; the Universal Serial Bus device determining whether the data read from the main partition is correct, and executing a corresponding operation according to a determination result; the Universal Serial Bus device transmitting a state and capacity information of the main partition to the host, and the Universal Serial Bus device not transmitting capacity information of the at least one backup partition to the host.

The present invention provides a system for realizing RAID-1 on a portable storage medium, a method for realizing writing data under RAID-1 on a portable storage medium, and a method for realizing writing/reading data under RAID-1 on a portable storage medium. The system and the methods divide the portable storage medium into a main partition and at least one backup partition according to a virtual RAID-1 mode. Therefore, in the present invention, when a Universal Serial Bus device writes data to the portable storage medium, the Universal Serial Bus device backs up the data in the at least one backup partition simultaneously. Thus, compared to the prior art, the present invention can solve a problem of a user not reading corresponding data from the portable storage medium again when the portable storage medium (not divided into a main partition and at least one backup partition) is abnormal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a system for realizing backup data under RAID-1 of redundant array of independent disks (RAID) on a portable storage medium according to an embodiment.

FIG. 2A is a diagram illustrating operation relationships among the Universal Serial Bus device, the portable storage medium and the host when the host transmits a write command according to a bulk-only transport protocol of a USB 3.0 specification.

FIG. 2B and FIG. 2C are diagrams illustrating operation relationships among the Universal Serial Bus device, the portable storage medium and the host when the host transmits a read command according to the bulk-only transport protocol of the USB 3.0 specification.

FIG. 3A is a diagram illustrating operation relationships among the Universal Serial Bus device, the portable storage medium and the host when the host transmits the write command according to a Universal Serial Bus device attached SCSI protocol of the USB 3.0 specification.

FIG. 3B and FIG. 3C are diagrams illustrating operation relationships among the Universal Serial Bus device, the portable storage medium and the host when the host transmits the read command according to the Universal Serial Bus device attached SCSI protocol of the USB 3.0 specification.

FIG. 4 is a flowchart illustrating a method for realizing writing data under RAID-1 on a portable storage medium in the bulk-only transport protocol of the USB 3.0 specification according to another embodiment.

FIG. 5 is a flowchart illustrating a method for realizing writing data under RAID-1 on a portable storage medium in the Universal Serial Bus device attached SCSI protocol of the USB 3.0 specification according to another embodiment.

FIG. 6 is a flowchart illustrating a method for realizing reading data under RAID-1 on a portable storage medium in the bulk-only transport protocol of the USB 3.0 specification according to another embodiment.

FIG. 7 is a flowchart illustrating a method for realizing reading data under RAID-1 on a portable storage medium in the Universal Serial Bus device attached SCSI protocol of the USB 3.0 specification according to another embodiment.

### DETAILED DESCRIPTION

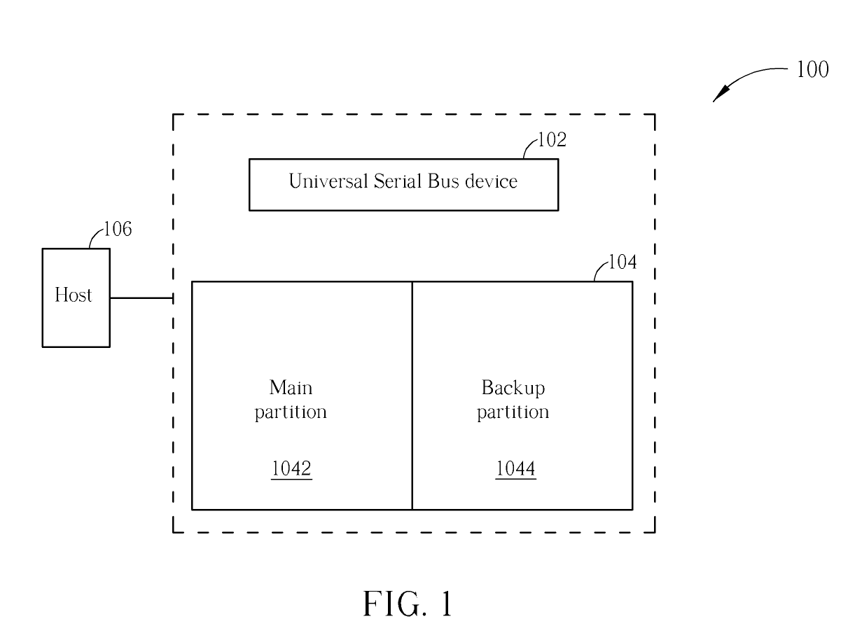

Please refer to FIG. 1. FIG. 1 is a diagram illustrating a system 100 for realizing backup data under RAID-1 of redundant array of independent disks (RAID) on a portable storage medium according to an embodiment. The system 100 includes a Universal Serial Bus device 102 and a portable storage medium 104. The Universal Serial Bus device 102 is used for receiving a write command and/or a read command transmitted by a host 106. The portable storage medium 104 is coupled to the Universal Serial Bus device 102. The host 106 can divide the portable storage medium 104 into a main partition 1042 and a backup partition 1044 according to a virtual RAID-1 mode. But, the present invention is not limited to the portable storage medium 104 only having one backup partition 1044. In addition, when the Universal Serial Bus device 102 transmits capacity information of the portable storage medium 104 to the host 106, the Universal Serial Bus device 102 only transmits capacity information of the main partition 1042 of the portable storage medium 104 to the host 106. That is to say, a user only sees the capacity information of the main partition 1042 of the portable storage medium 104, and does not know capacity information of the backup partition 1044.

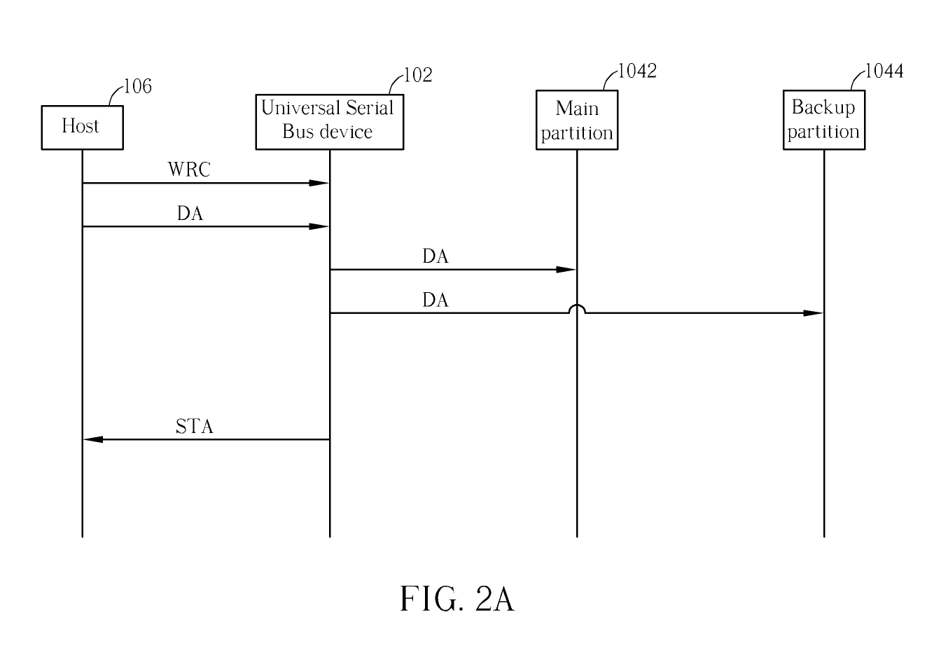

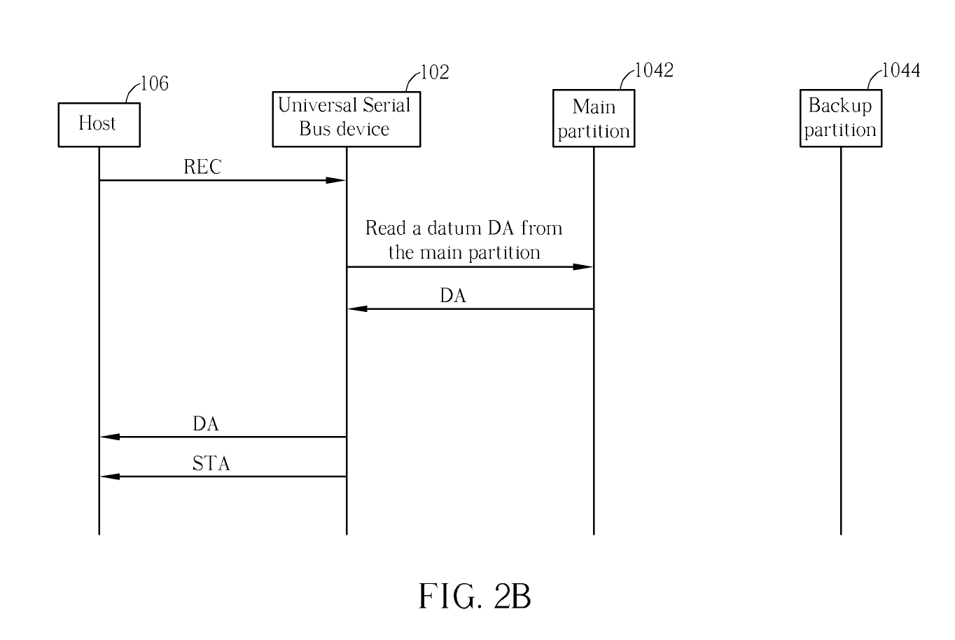

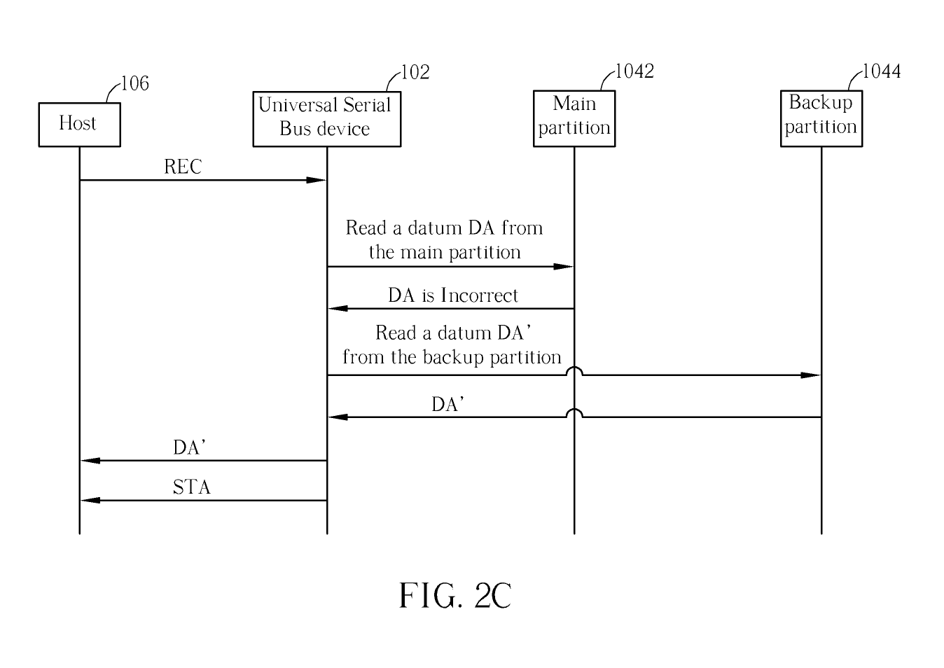

Please refer to FIG. 2A, FIG. 2B and FIG. 2C. FIG. 2A is a diagram illustrating operation relationships among the Universal Serial Bus device 102, the portable storage medium 104 and the host 106 when the host 106 transmits a write command WRC according to a bulk-only transport (BOT) protocol of a USB 3.0 specification, and FIG. 2B and FIG. 2C are diagrams illustrating operation relationships among the Universal Serial Bus device 102, the portable storage medium 104 and the host 106 when the host 106 transmits a read command REC according to the bulk-only transport protocol of the USB 3.0 specification. As shown in FIG. 2A, when the host 106 transmits the write command WRC to the Universal Serial Bus device 102, the Universal Serial Bus device 102 writes a datum DA transmitted by the host 106 to the main partition 1042 and the backup partition 1044 of the portable storage medium 104 according to the write command WRC. After the datum DA transmitted by the host 106 is written to the main partition 1042 and the backup partition 1044 of the portable storage medium 104, the Universal Serial Bus device 102 transmits a state STA to the host 106 for notifying the host 106 to deal with a next command (a write command or a read command).

As shown in FIG. 2B, when the host 106 transmits a read command REC to the Universal Serial Bus device 102, the Universal Serial Bus device 102 reads a datum DA corresponding to the read command REC from the main partition 1042 according to the read command REC, and the Universal Serial Bus device 102 determines whether the datum DA corresponding to the read command REC read from the main partition 1042 is correct according to a cyclic redundant check code (CRC). As shown in FIG. 2B, when the Universal Serial Bus device 102 determines that the datum DA corresponding to the read command REC is correct, the Universal Serial Bus device 102 transmits the datum DA to the host 106 and transmits a state STA to the host 106 for notifying the host 106 to deal with a next command. In another embodiment, the Universal Serial Bus device 102 can determine whether the datum DA corresponding to the read command REC read from the main partition 1042 is correct according to an error correction code (ECC), or other error detection and correction methods. As shown in FIG. 2C, when the Universal Serial Bus device 102 determines that the datum DA corresponding to the read command REC is incorrect, the Universal Serial Bus device 102 reads a datum DA′ corresponding to the read command REC from the backup partition 1044 according to the read command REC, and the Universal Serial Bus device 102 determines whether the datum DA′ corresponding to the read command REC read from the backup partition 1044 is correct according to the cyclic redundant check code or the error correction code. If the datum DA′ is correct, the Universal Serial Bus device 102 transmits the datum DA′ to the host 106. Because the portable storage medium 104 only has one backup partition, the Universal Serial Bus device 102 transmits a state STA to the host 106 for notifying the host 106 to deal with a next command regardless of whether or not the datum DA′ corresponding to the read command REC read from the backup partition 1044 is correct. If the portable storage medium 104 has a plurality of backup partitions, the Universal Serial Bus device 102 can continue performing the above mentioned operation of reading a datum corresponding to the read command REC until a datum corresponding to the read command REC is correct, or until the Universal Serial Bus device 102 can not read a correct datum corresponding to the read command REC in the plurality of backup partitions.

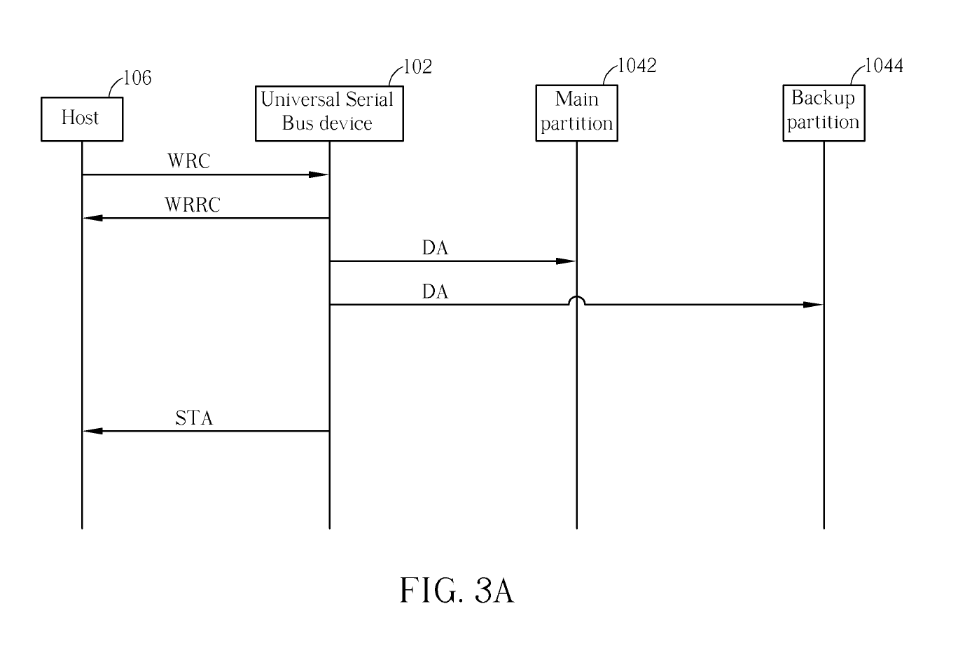

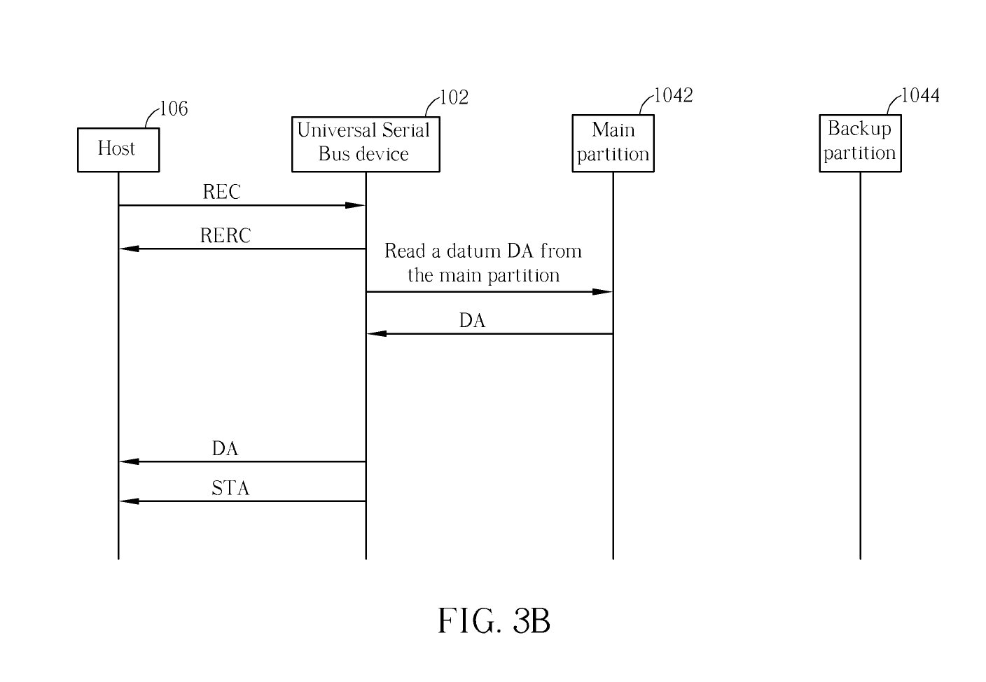

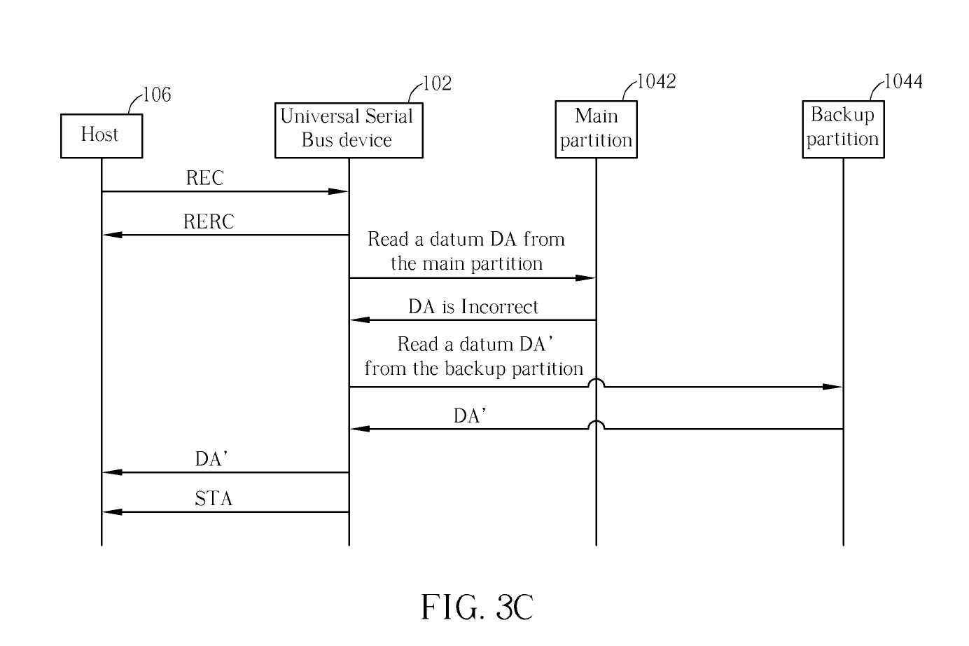

Please refer to FIG. 3A, FIG. 3B and FIG. 3C. FIG. 3A is a diagram illustrating operation relationships among the Universal Serial Bus device 102, the portable storage medium 104 and the host 106 when the host 106 transmits the write command WRC according to a Universal Serial Bus device attached SCSI protocol (UASP) of the USB 3.0 specification, and FIG. 3B and FIG. 3C are diagrams illustrating operation relationships among the Universal Serial Bus device 102, the portable storage medium 104 and the host 106 when the host 106 transmits the read command REC according to the Universal Serial Bus device attached SCSI protocol of the USB 3.0 specification. As shown in FIG. 3A, a difference between FIG. 3A and FIG. 2A is that when the host 106 transmits the write command WRC to the Universal Serial Bus device 102, the Universal Serial Bus device 102 transmits a write ready command WRRC to the host 106 after the Universal Serial Bus device 102 receives the write command WRC. Further, subsequent operational principles of FIG. 3A are the same as those of FIG. 2A, so further description thereof is omitted for simplicity. As shown in FIG. 3B, a difference between FIG. 3B and FIG. 2B is that the Universal Serial Bus device 102 transmits a read ready command RERC to the host 106 when the host 106 transmits the read command REC to the Universal Serial Bus device 102. Further, subsequent operational principles of FIG. 3B are the same as those of FIG. 2B, so further description thereof is omitted for simplicity. Similarly, a difference between FIG. 3C and FIG. 2C is that the Universal Serial Bus device 102 transmits the read ready command RERC to the host 106 when the host 106 transmits the read command REC to the Universal Serial Bus device 102. Further, subsequent operational principles of FIG. 3B are the same as those of FIG. 2B, so further description thereof is omitted for simplicity.

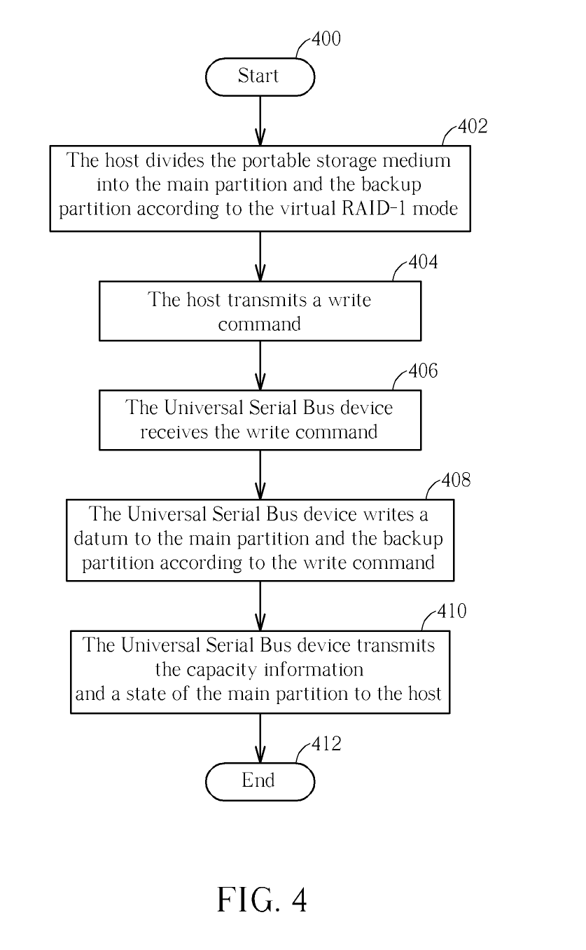

Please refer to FIG. 4. FIG. 4 is a flowchart illustrating a method for realizing writing data under RAID-1 on a portable storage medium in the bulk-only transport protocol of the USB 3.0 specification according to another embodiment. The method in FIG. 4 uses the system 100 in FIG. 1 to illustrate the method. Detailed steps are as follows:

Step 400: Start.

Step 402: The host 106 divides the portable storage medium 104 into the main partition 1042 and the backup partition 1044 according to the virtual RAID-1 mode.

Step 404: The host 106 transmits a write command WRC.

Step 406: The Universal Serial Bus device 102 receives the write command WRC.

Step 408: The Universal Serial Bus device 102 writes a datum DA to the main partition 1042 and the backup partition 1044 according to the write command WRC.

Step 410: The Universal Serial Bus device 102 transmits the capacity information and a state STA of the main partition 1042 to the host 106.

Step 412: End.

In Step 402, the present invention is not limited to the portable storage medium 104 only having one backup partition 1044. That is to say, the host 106 can divide the portable storage medium 104 into a main partition 1042 and a plurality of backup partitions according to the virtual RAID-1 mode. In Step 410, the Universal Serial Bus device 102 transmits the state STA of the portable storage medium 104 to the host 106 for notifying the host 106 to deal with a next command.

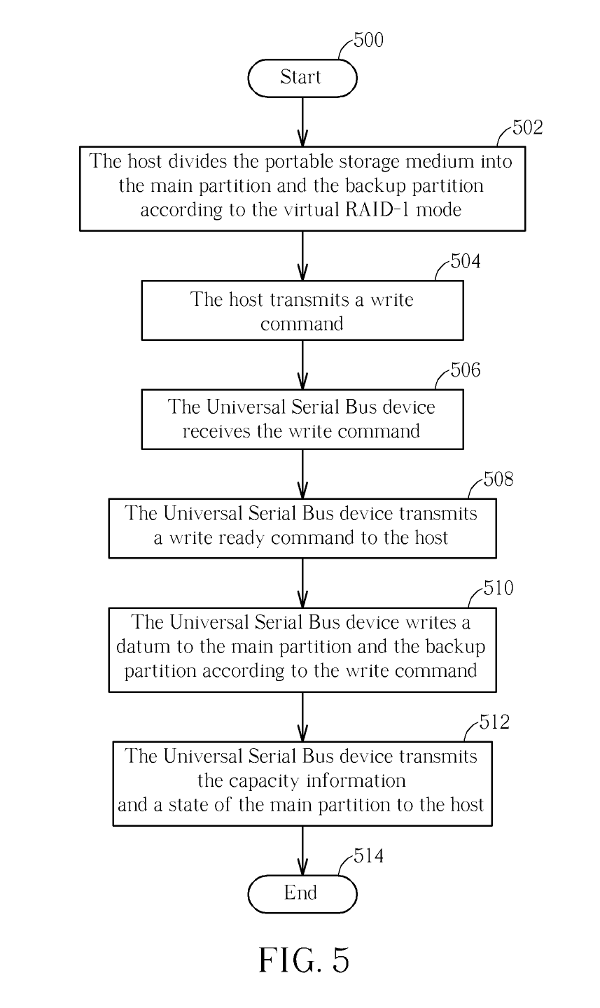

Please refer to FIG. 5. FIG. 5 is a flowchart illustrating a method for realizing writing data under RAID-1 on a portable storage medium in the Universal Serial Bus device attached SCSI protocol of the USB 3.0 specification according to another embodiment. The method in FIG. 5 uses the system 100 in FIG. 1 to illustrate the method. Detailed steps are as follows:

Step 500: Start.

Step 502: The host 106 divides the portable storage medium 104 into the main partition 1042 and the backup partition 1044 according to the virtual RAID-1 mode.

Step 504: The host 106 transmits a write command WRC.

Step 506: The Universal Serial Bus device 102 receives the write command WRC.

Step 508: The Universal Serial Bus device 102 transmits a write ready command WRRC to the host 106.

Step 510: The Universal Serial Bus device 102 writes a datum DA to the main partition 1042 and the backup partition 1044 according to the write command WRC.

Step 512: The Universal Serial Bus device 102 transmits the capacity information and a state STA of the main partition 1042 to the host 106.

Step 514: End.

A difference between the embodiment in FIG. 5 and the embodiment in FIG. 4 is that in Step 508, when the host 106 transmits the write command WRC to the Universal Serial Bus device 102, the Universal Serial Bus device 102 transmits the write ready command WRRC to the host 106 after the Universal Serial Bus device 102 receives the write command WRC. Subsequent operational principles of FIG. 5 are the same as those of FIG. 4, so further description thereof is omitted for simplicity.

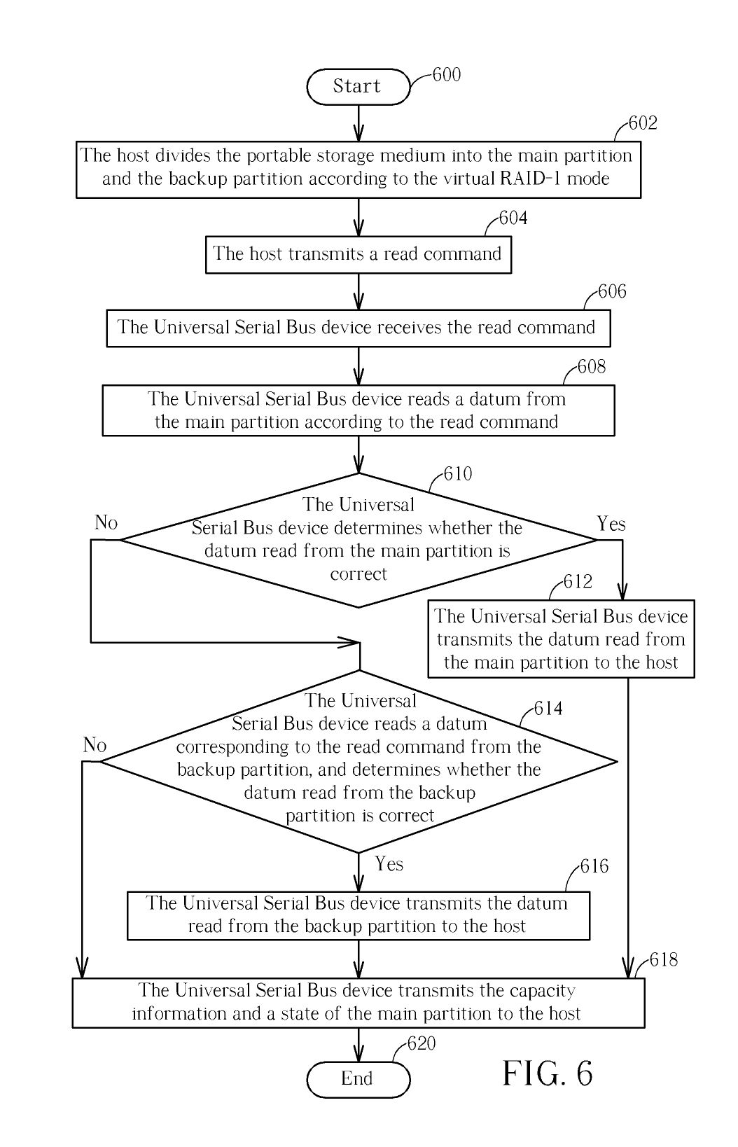

Please refer to FIG. 6. FIG. 6 is a flowchart illustrating a method for realizing RAID-1 data reading on a portable storage medium in the bulk-only transport protocol of the USB 3.0 specification according to another embodiment. The method in FIG. 6 uses the system 100 in FIG. 1 to illustrate the method. Detailed steps are as follows:

Step 600: Start.

Step 602: The host 106 divides the portable storage medium 104 into the main partition 1042 and the backup partition 1044 according to the virtual RAID-1 mode.

Step 604: The host 106 transmits a read command REC.

Step 606: The Universal Serial Bus device 102 receives the read command REC.

Step 608: The Universal Serial Bus device 102 reads a datum DA from the main partition 1042 according to the read command REC.

Step 610: The Universal Serial Bus device 102 determines whether the datum DA read from the main partition 1044 is correct. If yes, go to Step 612; if no, go to Step 614.

Step 612: The Universal Serial Bus device 102 transmits the datum DA read from the main partition 1044 to the host 106; go to Step 618.

Step 614: The Universal Serial Bus device 102 reads a datum DA′ corresponding to the read command REC from the backup partition 1044, and determines whether the datum DA′ read from the backup partition 1044 is correct. If yes, go to Step 616; if no, go to Step 618.

Step 616: The Universal Serial Bus device 102 transmits the datum DA′ read from the backup partition 1044 to the host 106.

Step 618: The Universal Serial Bus device 102 transmits the capacity information and a state STA of the main partition 1042 to the host 106.

Step 620: End.

In Step 608, the datum DA of the main partition 1042 corresponds to the read command REC. In Step 610, the Universal Serial Bus device 102 determines whether the datum DA corresponding to the read command REC read from the main partition 1042 is correct according to the cyclic redundant check code or the error correction code. In Step 614, when the Universal Serial Bus device 102 determines that the datum DA corresponding to the read command REC read from the main partition 1042 is incorrect according to the cyclic redundant check code or the error correction code, the Universal Serial Bus device 102 reads the datum DA′ corresponding to the read command REC from the backup partition 1044, and the Universal Serial Bus device 102 determines whether the datum DA′ corresponding to the read command REC read from the backup partition 1044 is correct according to the cyclic redundant check code or the error correction code. In Step 618, because the portable storage medium 104 only has one backup partition 1044, the Universal Serial Bus device 102 transmits the state STA to the host 106 for notifying the host 106 to deal with a next command no matter whether the datum DA′ corresponding to the read command REC read from the backup partition 1044 is correct. But, the present invention is not limited to portable storage medium 104 only having one backup partition 1044.

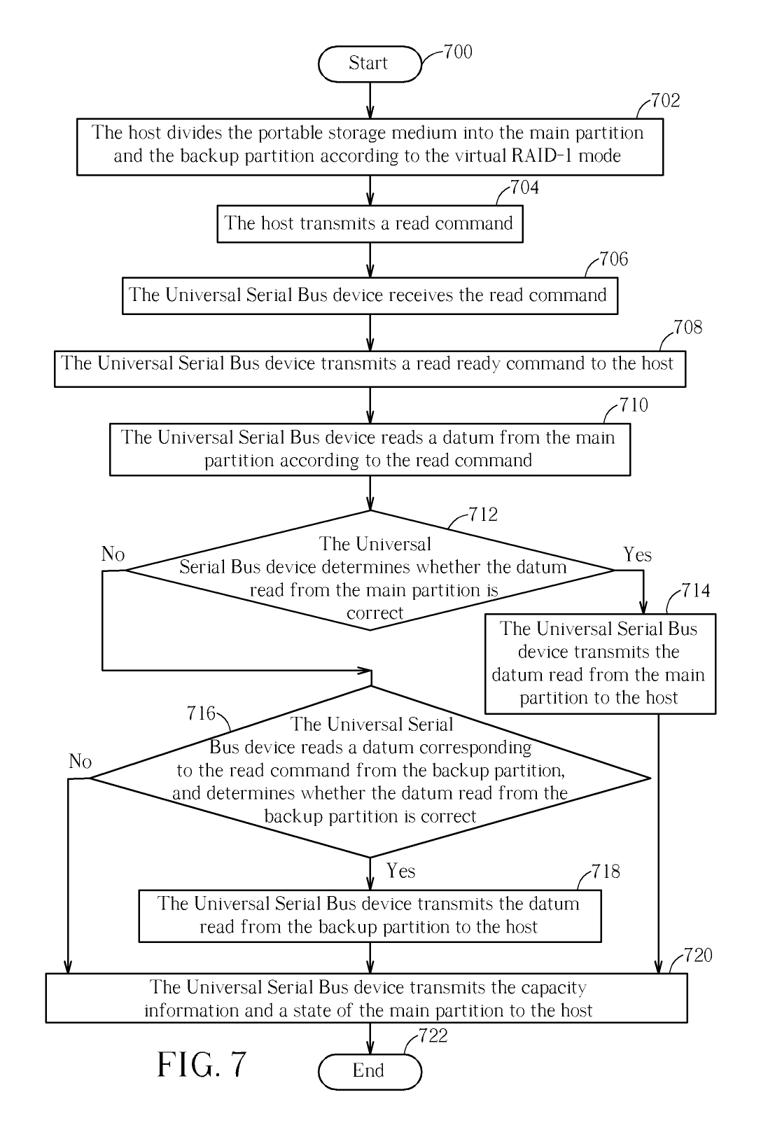

Please refer to FIG. 7. FIG. 7 is a flowchart illustrating a method for realizing reading data under RAID-1 on a portable storage medium in the Universal Serial Bus device attached SCSI protocol of the USB 3.0 specification according to another embodiment. The method in FIG. 7 uses the system 100 in FIG. 1 to illustrate the method. Detailed steps are as follows:

Step 700: Start.

Step 702: The host 106 divides the portable storage medium 104 into the main partition 1042 and the backup partition 1044 according to the virtual RAID-1 mode.

Step 704: The host 106 transmits a read command REC.

Step 706: The Universal Serial Bus device 102 receives the read command REC.

Step 708: The Universal Serial Bus device 102 transmits a read ready command RERC to the host 106.

Step 710: The Universal Serial Bus device 102 reads a datum DA from the main partition 1042 according to the read command REC.

Step 712: The Universal Serial Bus device 102 determines whether the datum DA read from the main partition 1044 is correct. If yes, go to Step 714; if no, go to Step 716.

Step 714: The Universal Serial Bus device 102 transmits the datum DA read from the main partition 1044 to the host 106; go to Step 720.

Step 716: The Universal Serial Bus device 102 reads a datum DA′ corresponding to the read command REC from the backup partition 1044, and determines whether the datum DA′ read from the backup partition 1044 is correct. If yes, go to Step 718; if no, go to Step 720.

Step 718: The Universal Serial Bus device 102 transmits the datum DA′ read from the backup partition 1044 to the host 106.

Step 720: The Universal Serial Bus device 102 transmits the capacity information and a state STA of the main partition 1042 to the host 106.

Step 722: End.

A difference between the embodiment in FIG. 6 and the embodiment in FIG. 7 is that in Step 708, when the host 106 transmits the read command REC to the Universal Serial Bus device 102, the Universal Serial Bus device 102 transmits the read ready command RERC to the host 106 after the Universal Serial Bus device 102 receives the read command REC. Subsequent operational principles of FIG. 7 are the same as those of FIG. 6, so further description thereof is omitted for simplicity.

To sum up, the system for realizing RAID-1 on the portable storage medium, the method for realizing writing data under RAID-1 on the portable storage medium, and the method for realizing writing/reading data under RAID-1 on the portable storage medium is to divide the portable storage medium into a main partition and at least one backup partition according to the virtual RAID-1 mode. Therefore, in the present invention, when the Universal Serial Bus device writes data to the portable storage medium, the Universal Serial Bus device backs up the data in the at least one backup partition simultaneously. Thus, compared to the prior art, the present invention can solve a problem of a user not reading corresponding data from the portable storage medium again when the portable storage medium (not divided into a main partition and at least one backup partition) is abnormal.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A system for realizing RAID-1 on a portable storage medium, the system comprising:
a portable storage medium, wherein the portable storage medium is divided into a main partition and at least one backup partition according to a virtual RAID-1 mode; and
a Universal Serial Bus device, coupled to the portable storage medium, for receiving a write command and/or a read command transmitted by a host, and writing data to the portable storage medium and/or reading data from the portable storage medium according to the write command and/or the read command;
wherein the Universal Serial Bus device does not transmit capacity information of the at least one backup partition to the host.

2. The system for realizing RAID-1 on a portable storage medium of claim. 1, wherein the Universal Serial Bus device transmits a state and capacity information of the main partition to the host after the Universal Serial Bus device writes the data to the portable storage medium and/or reads the data from the portable storage medium.

3. The system for realizing RAID-1 on a portable storage medium of claim 1, wherein the Universal Serial Bus device writes the data to the main partition and the at least one backup partition when the Universal Serial Bus device writes the data to the portable storage medium according to the write command.

4. The system for realizing RAID-1 on a portable storage medium of claim 1, wherein the Universal Serial Bus device reads the data corresponding to the read command from the main partition first when the Universal Serial Bus device reads the data corresponding to the read command from the portable storage medium according to the read command.

5. The system for realizing RAID-1 on a portable storage medium of claim 4, wherein the Universal Serial Bus device reads the data corresponding to the read command from the at least one backup partition when the data read from the main partition by the Universal Serial Bus device is incorrect.

6. The system for realizing RAID-1 on a portable storage medium of claim 5, wherein the Universal Serial Bus device determines whether the data read from the main partition is correct according to a cyclic redundant check code or an error correction code.

7. The system for realizing RAID-1 on a portable storage medium of claim 1, wherein the Universal Serial Bus device transmits a write ready command and/or a read ready command to the host after the Universal Serial Bus device receives the write command and/or the read command.

8. A method for realizing writing data under RAID-1 on a portable storage medium, the method comprising:
dividing the portable storage medium into a main partition and at least one backup partition according to a RAID-1 mode;
receiving a write command transmitted from a host by a Universal Serial Bus device;
the Universal Serial Bus device writing data to the main partition and the at least one backup partition according to the write command; and
the Universal Serial Bus device transmitting a state and capacity information of the main partition to the host, and the Universal Serial Bus device not transmitting capacity information of the at least one backup partition to the host.

9. The method of realizing writing data under RAID-1 on the portable storage medium of claim 8, further comprising:
the Universal Serial Bus device transmitting a write ready command to the host after the Universal Serial Bus device receives the write command.

10. The method of realizing writing data under RAID-1 on the portable storage medium of claim 9, wherein the Universal Serial Bus device writes the data to the main partition and the at least one backup partition according to the write command after the Universal Serial Bus device transmits the write ready command to the host.

11. A method for realizing writing/reading data under RAID-1 on a portable storage medium, the method comprising:
dividing the portable storage medium into a main partition and at least one backup partition according to a virtual RAID-1 mode;
receiving a read command transmitted from a host by a Universal Serial Bus device;
the Universal Serial Bus device reading data corresponding to the read command from the main partition according to the read command;
the Universal Serial Bus device determining whether the data read from the main partition is correct, and executing a corresponding operation according to a determination result; and
the Universal Serial Bus device transmitting a state and capacity information of the main partition to the host, and the Universal Serial Bus device not transmitting capacity information of the at least one backup partition to the host.

12. The method of realizing writing/reading data under RAID-1 on the portable storage medium of claim 11, further comprising:
the Universal Serial Bus device transmitting the data read from the main partition to the host when the data read from the main partition is correct.

13. The method of realizing writing/reading data under RAID-1 on the portable storage medium of claim 11, further comprising:
the Universal Serial Bus device reading the data corresponding to the read command from the at least one backup partition, and determining whether the data read from the at least one backup partition is correct when the data read from the main partition is incorrect.

14. The method of realizing writing/reading data under RAID-1 on the portable storage medium of claim 11, further comprising:
the Universal Serial Bus device determining whether the data read from the main partition is correct according to a cyclic redundant check code or an error correction code.

15. The method of realizing writing/reading data under RAID-1 on the portable storage medium of claim 11, further comprising:
the Universal Serial Bus device transmitting a read ready command to the host after the Universal Serial Bus device receives the read command.

16. The method of realizing writing/reading data under RAID-1 on the portable storage medium of claim 11, further comprising:
the Universal Serial Bus device receiving a write command from the host; and
the Universal Serial Bus device writing data to the main partition and the at least one backup partition according to the write command.

17. The method of realizing writing/reading data under RAID-1 on the portable storage medium of claim 16, further comprising:
the Universal Serial Bus device transmitting a write ready command to the host after the Universal Serial Bus device receives the write command.
